(19) United States
(12) Patent Application Publication
(10) Pub. No.: US 2007/0036547 A1
(43) Pub. Date: Feb. 15, 2007

(54) FTTP IP video overlay

(75) Inventors: Sean V. Blakley, Petaluma, CA (US); Pradeep D. Patel, Murphy, TX (US); Thomas E. Conklin, Leesburg, VA (US)

Correspondence Address: FITZPATRICK CELLA HARPER & SCINTO, 30 ROCKEFELLER PLAZA, NEW YORK, NY, 10112, US

(73) Assignee: TELLABS OPERATIONS, INC., Naperville, IL (US)

(21) Appl. No.: 11/201,553

(22) Filed: Aug. 10, 2005

(51) Int. Cl. H04J 14/00

(52) U.S. Cl. 398/71

(57) ABSTRACT

A video overlay system for a Fiber to the Premises (FTTP) optical network. The video overlay is achieved by including a video router with a gigabit Ethernet interface including Internet Group Management Protocol (IGMP) multicasting capability in a headend. The video router transmits unidirectional Internet Protocol video to a plurality of Single Family Unit (SFU) Optical Network Terminations (ONTs) at 1550 nm. The SFU ONTs include IGMP snooping (MxU ONT with multicasting) capability and carry bi-directional control signals from Set Top Boxes (STBs) using 1490 nm downstream and 1310 nm upstream traffic to the headend via an Optical Line Termination (OLT).

### BACKGROUND AND SUMMARY

1. Field of the Invention

The present invention relates generally to distribution of video to subscribers on a communications network and more specifically to distributing video over an optical network.

2. Description of the Related Art

There is a growing demand in the industry to find a solution to transmit video from a headend to a subscriber's premises through a fiber optic network all the way into an individual home or business. Such fiber optic networks are termed Fiber To The Home (FTTH) or Fiber To The Premises (FTTP) networks.

In a FTTP network, equipment at a headend or central office couples the FTTP to external services such as a Public Switched Telephone Network (PSTN) or an external network. Signals received from these services are converted into optical signals and are combined onto a single optical fiber at a plurality of wavelengths, with each wavelength defining a channel within the FTTP network. The optical signals are transmitted through the FTTP network to an optical splitter that splits the optical signals and transmits the optical signals over a single optical fiber to a subscriber's premises. At the subscriber's premises, the optical signals are converted into electrical signals using an Optical Network Termination (ONT). The ONT may split the resultant signals into separate services required by the subscriber such as computer networking, telephony and video.

In order to achieve video transmission or video overlay over a FTTP network, several different types of solutions have been proposed. In one type of solution, termed “out-of-band”, one wavelength of light in an optical network is dedicated to downstream (i.e. transmission from the headend to subscribers) overlay video services using Radio Frequency (RF) related technologies. In an out-of-band system, a conventional video cable style signal is converted from an electrical signal into an optical signal for transmission over the FTTP network. Once the optical signal is received at a subscriber's location, the optical signal is converted back into an electrical signal by the ONT for conventional processing by a Set Top Box (STB) coupling the video signal to a display device such as a television or a monitor.

Out-of-band solutions suffer from the problem that there is limited or no provisioning of upstream or back-channel (i.e. transmission of data from the subscriber's premises to the headend) transmissions. This limits the amount of data that may be transmitted back to the headend which may be required for advanced video services such as Video on Demand (VoD).

Another type of solution, termed “inband”, uses packetized video content distributed as conventional Internet Protocol (IP) signals through the FTTP network to an IP enabled STB coupled to a subscriber's ONT. However, such a video distribution architecture scales badly as the FTTP network must supply sufficient bandwidth to accommodate a large number of IP STBs requesting video data simultaneously. As such, an inband solution requires a large amount of bandwidth on the FTTP network.

In one variant of the inband solution, multicasting features are added to an Optical Line Termination (OLT) at a headend of a FTTP network and snooping capabilities are added to an ONT at a subscriber's premises. Although this variant of the inband approach is able to transmit IP video to the subscriber STBs, this still requires a large amount of system resources and is a complex and expensive solution.

In another variant of the inband solution, an ONT for interfacing to the FTTP network is supplemented with a separate device for interpreting protocols and performing media conversion for video distribution. However, this solution does not provide for additional data services to be provisioned from the ONT as the ONT and separate device are dedicated to video distribution.

Therefore, a need exists for a way to distribute video over an FTTP network that does not require large amounts of bandwidth yet provides sufficient upstream network traffic to accommodate advanced video services. An FTTP network with an IP video overlay in accordance with various aspects of the present invention meets such a need.

### SUMMARY OF THE INVENTION

In one embodiment of the invention, an optical system having a video overlay is provided. The optical system includes a headend, arranged to transmit downstream network signals through an optical network, the downstream network signals including at least multicast video signals on a first predetermined wavelength. An optical network termination is coupled to the headend via the optical network. The optical network termination is arranged to receive the downstream network signals from the headend, snoop the multicast video signals on the first predetermined wavelength, and route those multicast video signals to receiving destinations.

In another embodiment of the invention, a method of operating an optical network termination is provided. The method includes receiving downstream network signals from an optical network with the downstream network signals including at least multicast video signals on a first predetermined wavelength. The optical network termination snoops the multicast video signals on the first predetermined wavelength; and routes those multicast video signals to receiving destinations.

In another embodiment of the invention, an optical network termination for receiving multicast video signals from a video router over an optical network is provided. The optical network termination includes a wavelength division multiplexer/demulitplexer that demultiplexes the multicast video signals received over the optical network and a routing switch coupled to the wavelength division multiplexer/demulitplexer on a first wavelength, the routing switch snooping the multicast video signals. The routing switch has a networking port to transmit the video signals to at least one receiving destination.

In another embodiment of the invention, an overlay video system for a FTTP network is achieved by including a video router with a gigabit Ethernet interface including Internet Group Management Protocol (IGMP) multicasting capability in a headend. The video router transmits unidirectional IP video to a plurality of Single Family Unit (SFU) ONTs at 1550 nm. The SFU ONTs include IGMP snooping (MxU ONT with multicasting) capability and carry bi-directional control signals from STBs using 1490 nm downstream and 1310 nm upstream to the headend via an Optical Line Termination (OLT). This approach requires very small amount of resources in the OLT for the IP video services, such as the resources required for the bi-directional communication from STB to the headend. This approach allows a large amount of network bandwidth to be used for other applications like Video on Demand (VoD), high speed Internet access, etc.

This summary has been provided so that the nature of the invention may be understood quickly. A more complete understanding of the invention can be obtained by reference to the following detailed description, appended claims, and accompanying drawings.

### BRIEF DESCRIPTION OF THE DRAWINGS

FIG. 1 is a block diagram representing an IP video overlay for a FTTP network in accordance with an exemplary embodiment of the present invention.

FIG. 2 is a network diagram of an IP video overlay system for a FTTP network in accordance with an exemplary embodiment of the present invention.

FIG. 3 is a block diagram of an ONT in accordance with an exemplary embodiment of the present invention.

FIG. 4 is a sequence diagram of an IP video overlay process for a FTTP network in accordance with an exemplary embodiment of the present invention.

FIG. 5 is an architecture diagram of an ONT in accordance with an exemplary embodiment of the present invention.

### DETAILED DESCRIPTION

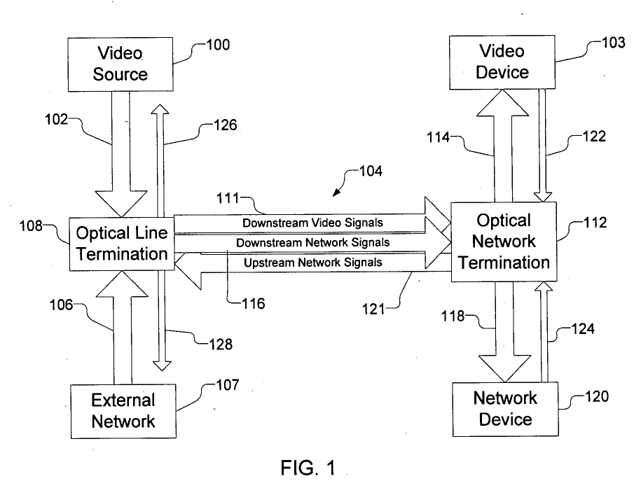

FIG. 1 is a block diagram representing an IP video overlay for a FTTP network in accordance with an exemplary embodiment of the present invention. Using an IP video overlay, downstream network video signals from a video source 100 including electrical video signals 102 intended for one or more subscribers may be routed to a video device 103 through a FTTP network 104. To do so, the downstream network video signals are combined, or overlaid, with other downstream network signals 106 from an external network 107 at a headend having an Optical Line Termination (OLT) 108. To overlay the downstream network video signals, the OLT 108 receives the electrical video signals 102 and assigns the electrical video signals 102 to a preassigned first optical wavelength utilized by the FTTP network 104. The electrical video signals 102 are converted into optical video signals in the first optical wavelength. The optical video signals are then transmitted in a downstream network video channel 111 via the FTTP network 104 to an Optical Network Termination (ONT) 112 located at a subscriber's premises. The ONT 112 receives the optical video signals in the downstream network video channel 111 and converts the optical video signals into electrical video signals 114 which are forwarded to the video device 103 for further processing and/or display.

A video source may include, but is not limited to, a cable television (CATV) headend, video server or any other type of video signal source that provides video transmissions intended for a subscriber's premises. Other types of video sources may be employed as well.

The external network 107 may include, but is not limited to, a Wide Area Network (WAN) such as the Internet, a Public Switched Telephone Network (PSTN) or any other type of external signal source that provides a service accessed by a subscriber from their premises. Other types of external networks may be employed as well.

A video device may include, but is not limited to, for example a STB capable of decoding video signals received from the ONT 112 and generating video signals to be used by a video display. Another example of a video device is a general purpose computer having programming instructions that enable the general purpose computer to receive the video signals from the ONT and generate video signals for display on a monitor. Other types of video devices may be employed as well.

The other downstream network signals 106 are preassigned to a second optical wavelength utilized by the FTTP network 104. Examples of other downstream network signals 106 include any type of signal transmitted from the external network such as telephony signals, WAN signals, Internet signals etc. The OLT 108 receives the other downstream network signals 106 from the external network 107 and generates downstream optical network signals in the second wavelength which are transmitted in a second downstream network channel 116 via the FTTP network 104 to the ONT 112. The ONT 112 receives the optical network signals in the downstream network channel 116 and converts them into electrical network signals 118 which are forwarded to a network device 120. As the ONT 112 receives the optical signals corresponding to the electrical network signals 118 on a separate optical wavelength than the optical signals corresponding to the electrical video signals 114, the network device 120 does not receive unrequested video traffic that unnecessarily burdens the operation of the network device 120.

A network device may include, but is not limited to, for example a personal computer and the like that a subscriber may wish to couple to a network. As another example, a network device may be a general purpose computing device having programming instructions that allow the general purpose computing device to process the network signals. In addition, a video device, such as a Set Top Box (STB) may operate as a network device when communicating non-video data, such as billing and configuration data, with other network devices.

The types and number of video sources 100, external networks 107, video devices 103, and network devices 120 are not limited only to those described above. In general, various embodiments of the present invention may be employed in any network with any suitable type of equipment that is capable of communicating over a network and there may be more or less than the number of such devices as depicted in FIG. 1.

To provide a channel for upstream network signals transmitted from the subscriber's premises to either the video source 100 or the external network 107, a third optical wavelength utilized by the FTTP network 104 is preassigned to an upstream network channel 121 used by both the video device 103 and the network device 120 to transmit signals from the subscriber's premises. Video upstream network signals 122 from the video device 103 and network upstream network signals 124 from the network device 120 are combined at the ONT 112 and transmitted through the FTTP network 104 utilizing the third wavelength. Upon reception, the OLT 108 separates the video upstream network signals 122 from the network upstream network signals 124 and routes the two separate streams, 126 and 128, based on routing information included in the upstream network signals.

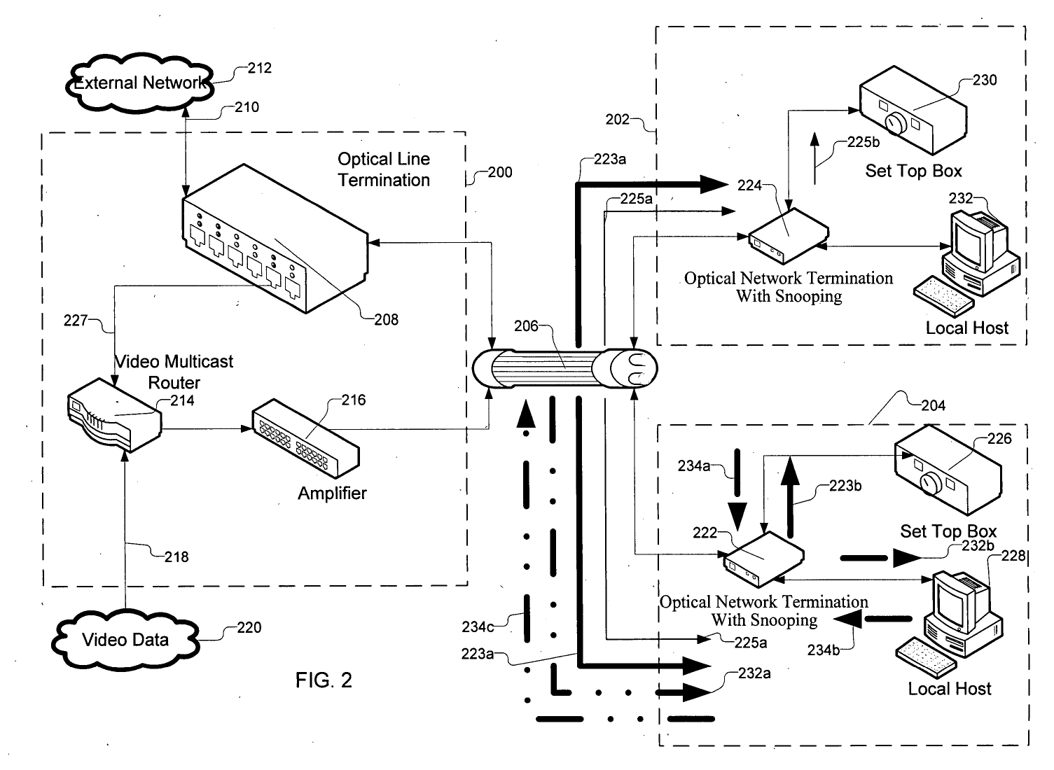

In accordance with one embodiment of the present invention, the FTTP network 104 and associated components OLT 108 and ONT 112 operate in accordance with a predetermined multicasting network protocol, such as the Internet Group Management Protocol (IGMP) as defined in Internet Engineering Task Force (IETF) Request For Comments (RFC) 1112. That is, the downstream video signals in the downstream network video channel 111 are IP video signals which are transmitted using the predetermined multicasting protocol wherein the video signals are assigned to separate video subchannels within the downstream network video channel 111. Each ONT, such as ONT 112, coupled to the FTTP network receives all of the multicast video signal channels. To determine which video channel should be forwarded to the video device 103, the ONT 112 monitors, or “snoops”, on the content of the multicast video signals and routes to the video device 103 only those signals that belong to a video subchannel preselected by the video device 103. Only those video signals selected for reception by the video device 103 are forwarded to the video device 103. The snooping process is described more fully in the discussion of FIG. 2.

In a preferred embodiment of the present invention, the first preassigned optical wavelength for the downstream network video channel 111 is 1550 nm, the second preassigned optical wavelength for the second downstream channel 116 is 1490 nm and the third preassigned optical wavelength for the upstream channel 121 is 1310 nm, although in other embodiments, other preassigned optical wavelengths may be employed instead.

Having described an overview of a video overlay for a FTTP network in accordance with the present invention, an exemplary embodiment of an IP video overlay system for a FTTP network in accordance with the present invention will now be described, with reference to FIG. 2. A headend 200 is coupled to one or more subscribers' premises, such as premises 202 and 204, via a FTTP network 206. The headend 200 includes an Optical Line Termination (OLT) 208 that is coupled to an external network 212 and the FTTP network 206, for routing network signals 210 through the FTTP network 206. In addition, the OLT 208 operates as an electrical-to-optical converter for coupling electrical signals received from the external network 212 to the FTTP network 206 and as an optical-to-electrical converter for coupling optical signals received from the FTTP network 206 to the external network 212.

A video multicast router 214 is coupled to the FTTP network via an optical amplifier 216. The video multicast router 214 receives one or more video signals 218 from a video source 220 and transmits them as optical video signals, 223a and 225a (representing separate video streams), on a first preassigned wavelength via the FTTP network 206 to the subscriber premises 202 and 204. The video multicast router 214 is also coupled to the OLT 208 for receiving upstream network signals 227 from the subscriber premises 202 and 204.

The subscriber's premises are coupled to the FTTP network via ONTs located at each subscriber's premises 202 and 204, such as ONT 222 and ONT 224, respectively. The ONTs 222 and 224 convert optical signals received from the FTTP network 206 into electrical signals that are routed to various video devices and network devices located at the subscriber's premises and vice versa. For example, ONT 222 routes downstream network signals to a video device, such as Set Top Box (STB) 226, and to a network device, such as local host 228, both of which are coupled to ONT 222. In a similar manner, ONT 224 is coupled to, and routes downstream network signals to STB 230 and local host 232.

The video multicast router 214 routes optical video signals, such as optical video signals 223a and 225a, through the FTTP network 206 and the ONTs 222 and 224 to a plurality of STBs, such as STBs 226 and 230, located at a plurality of subscriber's premises, such as premises 202 and 204, in a one to many relationship (i.e multicasting). That is, the video multicast router 214 can route a single optical video signal, such as optical video signal 223a, to more than one subscriber STB, such as STBs 226 and 230. In addition, all of the routed video signals, such as 223a and 225a, are transmitted via the FTTP network 206 to each the ONTs, such as ONTs 222 and 224, in the FTTP network 206. This alleviates network congestion as a video router need not route an individual optical video signal to each individual STB in a one-to-one relationship as in an inband video distribution system as discussed above. Instead, the video multicast router 214 can route a single optical video signal to a plurality of STBs that have requested the same optical video signal without duplicating any optical video signals as would be called for in the inband solution.

The video multicast router 214 operates by receiving join messages from STBs 226 and 230. The STBs 226 and 230 transmit the join messages to the video multicast router 214 to establish membership in a multicast group.

Membership of the STBs 226 and 230 in a multicast group is established by using Group Destination Addresses (GDAs). For each GDA, there is an associated Media Access Control (MAC) address. The STBs 226 and 230 issue a join message to join a specific multicast group GDA. When the video multicast router 214 receives the join message, the video multicast router 214 will add the GDA to a multicast routing table (not shown) and start forwarding video traffic to this group. Membership queries are issued by video multicast router 214 at regular intervals to check whether the STBs 226 and 230 are still interested in the GDA associated with the video traffic. In addition, Membership reports are sent by the STBs 226 and 230 to the video multicast router 214 either when the the STBs 226 and 230 want to receive GDA video traffic or in response to a membership query from the video multicast router 214.

The ONTs 222 and 224 monitor (snoop on) the transmissions of the video multicast router 214, such as the optical video signals 223a and 225a, and determine if the ONTs should forward the optical video signals as electrical video signals to the video devices to which the ONTs are coupled. In FIG. 2, this is illustrated by optical video signal 223a being routed as electrical video signal 223b to STB 226 by ONT 222. In a similar manner, ONT 224 routes optical video signal 225a as electrical video signal 225b to STB 230.

In general, an ONT also enables downstream network signals to be transmitted to a local host or an STB. For example, the ONT 222 enables optical downstream network signals 232a to be transmitted to the local host 228 or the STB 226. The optical downstream network signals 232a are received over the FTTP network 206 encoded in a second preassigned optical wavelength. The ONT 222 receives the optical downstream network signals 232a and forwards them as electrical network signals 232b, to the local host 228 or STB 226 based on the routing information included in the network signals.

The ONTs 222 and 224 and OLT 208 also enable data traveling upstream from the STBs 226 and 230 and local hosts 228 and 232 to be transmitted to the headend 200. For example, ONT 222 receives upstream network signals, such as upstream network signals 234b received from local host 228 and upstream network signals 234a received from STB 226 and combines them to create optical upstream network signals 234c in a channel on the FTTP network located at a third preassigned wavelength. At the headend 200 the OLT 208 receives the optical upstream network signals and routes them either to the external network 212 or the video multicast router 214 based on the routing information in the optical upstream network signals.

In an exemplary embodiment of the present invention, the video multicast router 214 is a gigabit Ethernet interface with multicasting capability which transmits unidirectional Internet Protocol (IP) video to the ONTs 222 and 224 at 1550 nm. Also in accordance with an exemplary embodiment of the present invention, each of the ONTs 222 and 224 is a Single Family Unit (SFU) ONT with Internet Group Management Protocol (IGMP) snooping (MxU ONT with multicasting) capability and carries bi-directional control signals from and to the STBs 226 and 230 using 1490 nm downstream and 1310 nm upstream to the headend 200 via the OLT 208. In this arrangement, incoming downstream network signals are separated from incoming video signals on two separate wavelengths. As the ONTs 222 and 224 process the incoming signals separately, the ONTs 222 and 224 need only snoop on the incoming video signals while routing the incoming network signals normally.

In this embodiment, ONTs 222 and 224 incorporate switches supporting IGMP snooping which can passively snoop on IGMP join, report and leave messages transferred between video multicast router 214 and the STBs 226 and 230 to determine multicast group memberships of STBs 226 and 230. The ONTs 222 and 224 check the IGMP messages passing through them, picking out group registration information and storing the group registration information in a routing table for routing video signals associates with the registered groups to the STBs 226 and 230.

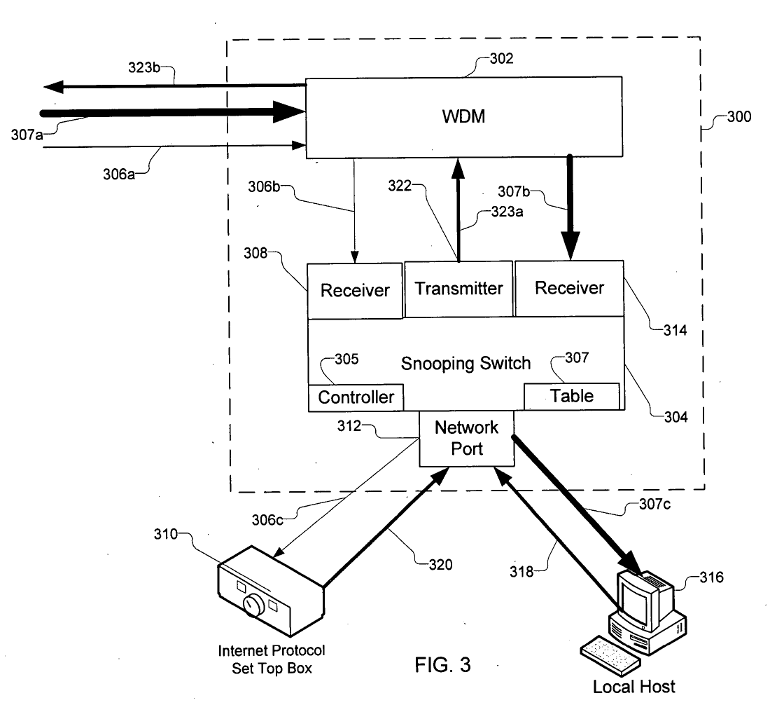

FIG. 3 is a block diagram of an ONT 300 coupled to a STB 310 and a local host 316 in accordance with an exemplary embodiment of the present invention. The ONT 300 is an example of ONTs 222 and 224, both of FIG. 2. The ONT 300 includes a Wavelength Division Multiplexer (WDM) 302 coupled to a snooping switch 304 having a controller 305. The WDM 302 operates as a multiplexer when it combines outgoing optical network signals on separate wavelengths for transmission through a FTTP network (not shown in FIG. 3) and operates as a demultiplexer when it receives incoming optical network signals on separate wavelengths from the FTTP network and separates them into separate channels. The WDM 302 receives optical downstream video signals 306a at a first preassigned wavelength, corresponding to downstream network video channel 111 of FIG. 1, from the FTTP network. The WDM 302 receives other types of optical downstream network signals 307a, corresponding to the second downstream channel 116 of FIG. 1, in a second preassigned wavelength. The WDM 302 routes the optical downstream video signals 306a as optical video signals 306b at the first wavelength to a first network receiver 308, such as a gigabit Ethernet receiver, coupled to the switch. The first receiver 308 receives the optical video signals and converts them to electrical video signals that are forwarded to the switch 304. The switch's controller 305 analyzes (snoops on) the electrical video signals and determines which multicasting group video signals belong to a video channel to which the STB 310 subscribes to by analyzing multicasting routing information in the electrical video signals. The controller 305 then forwards the electrical video signals determined to belong to the multicasting group as electrical video signals 306c to the STB 310 through a network port 312, such as a 10/100 Ethernet port.

The WDM 302 routes the second wavelength in which non-video optical network signals 307b are carried to a second receiver 314 coupled to the switch 304. The controller 305 forwards these optical network signals as electrical network signals 307c through the network port 312 to a local host 316 or the STB 310 without snooping on the signals.

The switch 304 also receives upstream network signals, 320 and 318, from the STB 310 and the local host 316 at the network port 312. The controller 305 uses an optical transmitter 322 to combine the upstream network signals 320 and 318 for transmission through the FTTP network as optical upstream network signals 323a using a third preassigned wavelength. These optical network signals 323a are transmitted through the FTTP network as optical upstream network signals 323b, corresponding to upstream network channel 121 of FIG. 1, using the WDM 302.

The signals transmitted by the STB 310 to a headend may include so-called join messages allowing the STB 310 to inform the controller 305 that the STB 310 should receive video signals addressed to a specific multicast group. The controller 305 stores these join messages in a routing table 307 and subsequently uses the stored information to route received video signals to the STB 310 when the video signals are detected and identified as belonging to the specific multicast group, through snooping of the optical video signals 306b.

In one embodiment of an ONT in accordance with the present invention, the ONT is adapted to snoop on join messages as defined in the IGMPv1 protocol as specified in IETF RFC 1112 or later versions thereof. In other embodiments of an ONT, the ONT may be adapted to use join messages from other protocols.

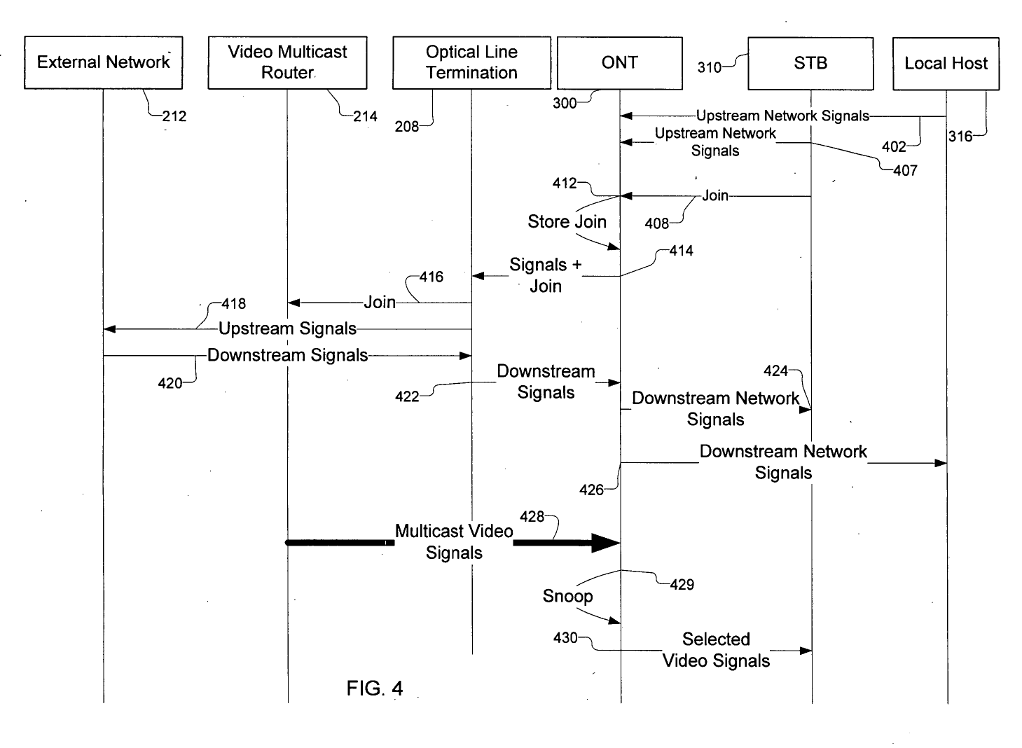

FIG. 4 is a sequence diagram of an IP video overlay process for a FTTP network in accordance with an exemplary embodiment of the present invention. A local host 316 transmits upstream network signals 402 to an ONT 300 for transmission through a FTTP network (not shown in FIG. 4) to an external network 212. In addition, a STB 310 transmits additional upstream network signals 407 to the ONT 300 for transmission via the FTTP network. The additional upstream network signals 407 from the STB 310 may be related to management of the STB 310 such as subscriber permissions, reporting subscriber usage, billing information, electronic programming guides, recording of content, etc. The STB 310 may also transmit a join message 408 to the ONT 300 for transmission through the FTTP network to a video multicast router 214. The ONT 300 stores (412) the join message 408 in a routing table (for example, the routing table 307 of FIG. 3) for later reference before transmitting the upstream network signals and join messages (identified collectively as 414) through the FTTP network to an OLT 208 at a third preassigned wavelength corresponding to upstream network channel 121 of FIG. 1.

The OLT 208 receives the upstream network signals and join messages in collective messages 414 from the ONT and routes them based on the routing information in the network signals, 402 and 407, and join messages 414. The join messages 416 are routed to the video multicast router 214 and the rest of the network signals 418 may be routed out to an external network 212.

The OLT 208 also receives downstream network signals 420 intended for the local host 316 or the STB 310 from the external network 212. The OLT 208 routes the downstream network signals 422 through the FTTP network at a second wavelength, corresponding to second downstream channel 116 of FIG. 1, towards the STB 310 and local host 316 through the ONT 300. The ONT 300 receives the downstream network signals 422 and, if the downstream network signals 422 are intended for either the STB 310 or the local host 316, the ONT 300 forwards the network signals, 424 and 426, to the STB 310 and local host 316.

In response to join messages received from STB 310, the video multicast router 214 transmits multicast video signals 428 having multiple video channels through the FTTP network to the STB 310. The video multicast router 214 transmits the multicast video signals 428 at a first preassigned wavelength dedicated to video signal transmissions. The ONT 300 receives the multicast video signals 428 and snoops (429) on the multicast video signals to find packets in the multicast video signals having routing information corresponding to the entries in the ONT's 300 routing table indicating which multicast video channels the STB 310 has previously joined. If the ONT 300 determines that the STB 310 has requested to join a particular video channel within the video multicast signals 428, the ONT 300 then routes video signals 430 associated with the selected video channel to the STB 310 for further processing therein in a manner known in the art.

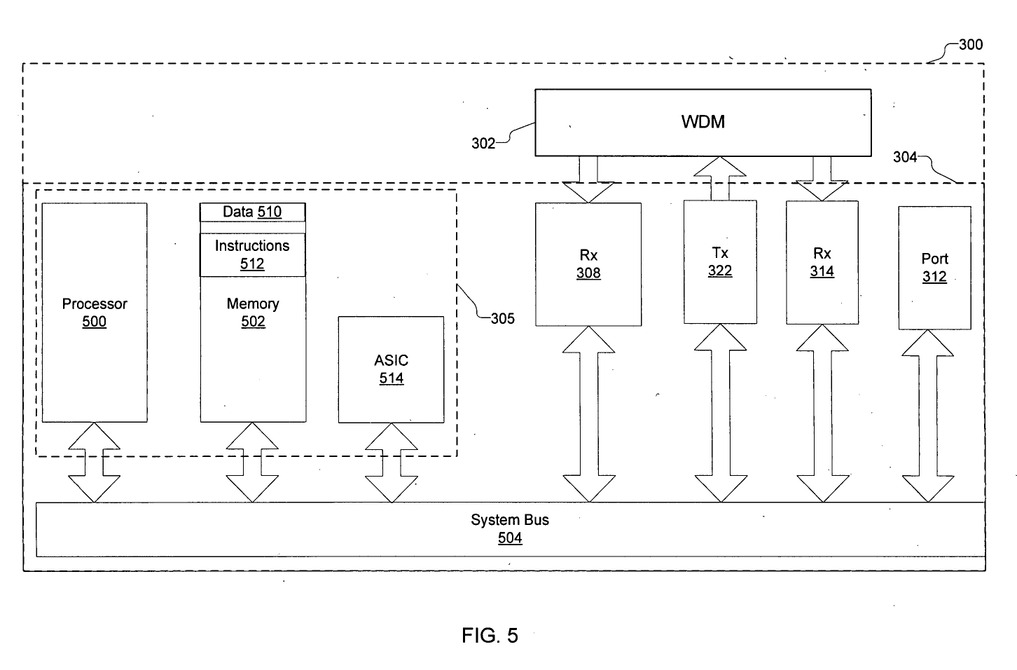

FIG. 5 is an architecture diagram of an ONT 300 in accordance with an exemplary embodiment of the present invention. This is a more detailed diagram than the block diagram presented in FIG. 3. ONT 300 includes WDM 302 coupled to switch 304 at one or more wavelengths. Switch 304 also includes controller 305 which controls the operation of the switch and provides switch 304 with multicast snooping capabilities. Controller 305 includes a processor 500 coupled to a memory 502 via a system bus 504. Memory 502 stores processor executable instructions 512 and data 510 used by controller 305 to operate switch 304 and WDM 302 to implement the features of ONT 300 as described above. In addition, processor 500 stores join messages received by ONT 300 in memory 502.

Processor 500 is further coupled to Input/Output (I/O) devices via system bus 504. I/O devices include first network receiver 308 coupled to WDM 302 at a first wavelength, second network receiver 314 coupled to WDM 302 at a second wavelength, network communications port 312, and network transmitter 322 coupled to WDM 302 at a third wavelength. In operation, WDM 302 receives optical network signals from a FTTP network (not shown in FIG. 5) encoding downstream video signals in the first wavelength and other types of network signals in the second wavelength. WDM 302 routes the optical video signals at the first wavelength to first network receiver 308 coupled to switch 304. First receiver 308 receives the optical video signals and converts them to electrical signals that are sent to switch 304. The controller 305 snoops on the video signals by analyzing the video signals to determine which video signals belong to a video channel to which a STB (not shown in FIG. 5) subscribes to and forwards those video signals to the STB through network communications port 312.

WDM 302 routes the second wavelength in which network signals (i.e., the non-multicast video signals) are carried to second receiver 314 coupled to switch 304. Controller 305 forwards these network signals through network communications port 312 to a local host (not shown in FIG. 5) or an STB (not shown in FIG. 5) without snooping on the signals.

Switch 304 receives upstream network signals from the STB (not shown in FIG. 5) and the local host (not shown in FIG. 5) at network communications port 312. Controller 305 uses optical transmitter 322 to convert the upstream network signals for transmission as optical upstream network signals via the FTTP network (not shown in FIG. 5) using a third wavelength. These optical upstream network signals are sent into the FTTP network (not shown in FIG. 5) via the WDM 302.

Controller 305 may further include an Application Specific Integrated Circuit (ASIC) 514 that is dedicated to snooping on the video network signals received at first receiver 308. This improves the speed at which controller 305 may snoop on the signals by unloading the snooping operations from processor 500.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. An optical system having a video overlay, comprising:
a headend, arranged to transmit downstream network signals through an optical network, the downstream network signals including at least multicast video signals on a first predetermined wavelength; and
an optical network termination coupled to the headend via the optical network, the optical network termination arranged to receive the downstream network signals from the headend, snoop the multicast video signals on the first predetermined wavelength, and route those multicast video signals to receiving destinations.

2. The optical system of claim 1, wherein the optical network includes a Fiber To The Premises (FTTP) optical network.

3. The optical system of claim 1, wherein the optical network termination comprises:
a wavelength division demulitplexer arranged to receive and demultiplex the downstream network signals received from the headend; and
a routing switch coupled to an output of the wavelength division demultiplexer, the routing switch having a multicast snooping capability to snoop the multicast video signals included on the first predetermined wavelength, and route those multicast video signals to the receiving destinations.

4. The optical system of claim 3, further comprising a network receiver coupled between the output of the wavelength division demultiplexer and the routing switch, wherein the network receiver is a Gigabit Ethernet receiver.

5. The optical system of claim 3, wherein the routing switch further comprises a networking port forwarding multicast video signals routed by the routing switch to the receiving destinations.

6. The optical system of claim 5, wherein the networking port utilizes the Ethernet protocol.

7. The optical system of claim 1, wherein the headend comprises a video router, having a multicast capability, the video router providing the multicast video signals.

8. The optical system of claim 1, wherein the headend and the optical network termination each operate in accordance with the Internet Group Management Protocol (IGMP) protocol.

9. The optical system of claim 1, wherein the downstream network signals also include other downstream signals carried on a second predetermined wavelength in the optical system

10. The optical system of claim 9, wherein the optical network termination also transmits upstream network signals carried on a third predetermined wavelength to the headend, through the optical network.

11. The optical system of claim 10, wherein the optical network termination further comprises a networking port through which the upstream network signals are supplied to the optical network termination, and through which the multicast video signals are routed by the optical network termination.

12. The optical system of claim 9, wherein the optical network termination transmits the other downstream signals to an external device.

13. The optical system of claim 3, wherein the routing switch further comprises an application specific integrated circuit performing snooping.

14. A method of operating an optical network termination, comprising:
receiving downstream network signals from an optical network, the downstream network signals including at least multicast video signals on a first predetermined wavelength;
snooping the multicast video signals on the first predetermined wavelength; and
routing those multicast video signals to receiving destinations.

15. The method of claim 14, wherein the optical network includes a Fiber To The Premises (FTTP) optical network.

16. The method of claim 14, further comprising demultiplexing the received downstream network signals.

17. The method of claim 14, wherein the receiving is performed by a Gigabit Ethernet network receiver of the optical network termination.

18. The method of claim 14, wherein the routing routes the multicast video signals through a networking port.

19. The method of claim 18, wherein the networking port utilizes the Ethernet protocol.

20. The method of claim 14, wherein the optical network termination operates in accordance with the Internet Group Management Protocol (IGMP) protocol.

21. The method of claim 14, wherein the downstream network signals further include other downstream signals carried on a second predetermined wavelength in the optical system.

22. The method of claim 21, further comprising transmitting upstream network signals carried on a third predetermined wavelength through the optical network.

23. The method of claim 22, further comprising receiving the upstream network signals by the optical network termination through a networking port, and wherein the multicast video signals are routed through the networking port.

24. The method of claim 21, further comprising forwarding the other downstream signals from the optical network termination to an external device.

25. An optical network termination for receiving multicast video signals from a video router over an optical network, the optical network termination comprising:
a wavelength division multiplexer/demulitplexer that demultiplexes the multicast video signals received over the optical network; and
a routing switch coupled to the wavelength division multiplexer/demulitplexer on a first wavelength, the routing switch snooping the multicast video signals,
wherein the routing switch has a networking port to transmit the video signals to at least one receiving destination.

26. The optical network termination of claim 25, wherein the optical network termination also receives other, downstream network signals carried on a second wavelength over the optical network, and the optical network termination further comprises:
a first network receiver, coupled between the wavelength division multiplexer/demulitplexer and the routing switch, the first network receiver receiving the multicast video signals from the wavelength division multiplexer/demulitplexer on the first wavelength, and
a second network receiver, coupled between the wavelength division multiplexer/demulitplexer and the routing switch, the second receiver receiving the other, downstream network signals from the wavelength division multiplexer/demulitplexer on the second wavelength,
wherein the networking port transmits the other, downstream network signals to an external device.

27. The optical network termination of claim 26, wherein the optical network termination further comprises a network transmitter coupled between the routing switch and the wavelength division multiplexer/demulitplexer, wherein the network transmitter transmits, through the optical network, upstream network signals supplied to the network transmitter from an external device through the networking port of the routing switch, and wherein the upstream network signals are carried on a third wavelength.

28. The optical network termination of claim 25, wherein the routing switch further comprises an application specific integrated circuit that performs the snooping of the multicast video signals.
